(19) United States
(12) Patent Application Publication
(10) Pub. No.: US 2009/0127254 A1
(43) Pub. Date: May 21, 2009

(54) Induction coil, method and device for inductive heating of metallic components

(75) Inventors: Joachim Bamberg, Dachau (DE); Alexander Gindorf, Schwabhausen (DE); Herbert Hanrieder, Hohenkammer (DE); Guenter Zenzinger, Petershausen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/291,737

(22) Filed: Nov. 13, 2008

(30) Foreign Application Priority Data
Nov. 16, 2007 (DE) 10 2007 054 782.1

(51) Int. Cl. H05B 6/36

(52) U.S. Cl. 219/672

(57) ABSTRACT

An induction coil for inductive heating of at least one metallic component having at least one lateral face and at least one face to be heated is provided. The induction coil includes a meandering pattern section shaped around the at least one component in such a way that the section extends over at least a partial area of the at least one lateral face of the at least one component to be heated in the area of the at least one face to be heated. A device and method for inductive heating of at least one metallic component are also provided.

This application claims priority to German Patent Application DE 10 2007 054 782.1, filed Nov. 16, 2007, which is incorporated by reference herein.

The present invention relates to an induction coil for use in a method for inductive heating of metallic components, in particular components of a gas turbine, each component having one or more lateral faces surrounding the particular component cross section. The present invention also relates to a method and a device for inductive heating of metallic components, in particular components of a gas turbine, and a component manufactured by this method.

### BACKGROUND

DE 198 58 702 A1 describes a pressure welding method for joining blade components of a gas turbine in which a vane section and at least one other blade component are provided. Corresponding joining faces of these elements are positioned essentially flush and at a distance from one another and are then joined together by exciting an inductor with a high-frequency current and bringing the parts together, so that their joining faces come in contact. In this inductive high-frequency pressure welding, sufficiently high and homogeneous heating of the two parts to be welded together is of crucial importance for the quality of the joint.

Additional inductive high-frequency pressure welding methods are known from EP 1 112 141 B1 and EP 1 140 417 B1. These methods are used to repair and manufacture an integrally bladed rotor for a turbo-engine or for joining blade components of a gas turbine in general. An inductor situated in the area of the front and rear edges of a blade at a greater distance from the joint face than in the central area of the blade is used here. The induced high-frequency electric current should heat as uniformly as possible the end face of the blade components that are to be joined and should only cause the areas near the end face or the surface to become molten.

Essentially, the problem that arises with methods for inductive heating of metallic components is that a uniform heating of the components to be machined and joined is very difficult to achieve independently of their cross section. With large and/or almost square joining faces in particular, the current flow and thus the heating of the joining faces by known induction coils are uneven.

### SUMMARY OF THE INVENTION

An object of the present invention is therefore to provide an induction coil according to the definition of the species, with which uniform heating of metallic components is ensured, regardless of the their cross section and in particular with large and/or almost square joining faces.

Another object of the present invention is to provide a method for inductive heating of metallic components, in particular components of a gas turbine, in which a uniform heating of metallic components is ensured, regardless of their cross section, in particular with large and/or almost square joining faces.

In addition, an object of the present invention is to provide a device for inductive heating of metallic components, in particular components of a gas turbine, in which uniform heating of metallic components is possible regardless of their cross section and in particular with large and/or almost square joining faces.

An induction coil according to an embodiment of the present invention for use in a method for inductive heating of metallic components, in particular components of a gas turbine, is designed in a meandering pattern and is shaped around the component(s) in such a way that it extends over at least a partial area of one or more lateral faces of the component(s) to be heated, surrounding the particular component cross section, in the area of one or more faces to be heated. The three-dimensional design of the induction coil according to an embodiment of the present invention makes it possible to guide the current flow in such a way that—in contrast with the coils that are designed to be flat and are known from the related art—it acts over almost the entire area of the faces to be machined, e.g., the joining faces of the components, and thus a uniform heating of the entire machining zone or joining zone is achieved independently of the cross section of the components. With large and/or almost square joining faces in particular, the current flow and thus the heating of the joining faces are uniform. Furthermore, the current flow between two faces to be joined is intensified. In addition, the induction coil according to an embodiment of the present invention permits a heat input into faces of varying width; furthermore, the component to be machined is easily extracted because the induction coil usually does not completely surround the component.

In an advantageous embodiment of the induction coil according to the present invention, the three-dimensional design of the induction coil is adapted to the geometry of the component(s) to be machined. This in turn ensures a uniform heating of the metallic components in a working range of the induction coil.

In another advantageous embodiment of the induction coil, the three-dimensional design of the induction coil is designed in such a way that the current on the face(s) flows perpendicularly to the areas of the induction coil parallel to one another on a top side and a bottom side of the components. Here again, uniform heating of the entire surface to be machined or the surfaces to be joined to one another is ensured.

In another advantageous embodiment of the induction coil according to the present invention, the coil has at least one cooling device. This cooling device ensures that there is no (partial) melting of the induction coil itself.

In another advantageous embodiment of the induction coil according to the present invention, the method for inductive heating is an inductive low-frequency or high-frequency pressure welding method for joining metallic components, in particular components of a gas turbine. The frequencies used here are selected from a range between 0.05 and 2.5 MHz. The induction coil according to the present invention ensures that the current flow acts across the joining faces of the components to be joined and produces uniform heating of the entire joining zone, regardless of the cross section of the components.

A method according to an embodiment of the present invention for inductive heating of metallic components, in particular components of a gas turbine, where the components each have one or more lateral faces surrounding the particular component cross section, includes the following steps: a) providing one or more components to be heated; b) bringing at least one induction coil onto the component(s) or bringing the component(s) onto the at least one induction coil, the induction coil being designed with a meandering pattern and shaped around the component(s) in such a way that the induction coil extends over at least a partial area of the lateral face(s) of the component(s) to be heated in the area of one or more faces to be heated, and inserting the component(s) to be heated into the induction coil; and c) inductive heating of the component(s) in a working range of the induction coil. The method according to the present invention ensures that there is uniform heating of the metallic components independently of their cross section due to the three-dimensional design of the induction coil used. In particular with large and/or almost square joining faces, the current flow and thus the heating of the joining faces are uniform because the current flow is guided in such a way that it is able to act over almost the entire area of the surfaces to be machined, e.g., joining faces of the components.

In an advantageous embodiment of the method according to the present invention, the three-dimensional design of the induction coil is adapted to the geometry of the component(s). Therefore, a uniform heating of the metallic components in a working range of the induction coil is again ensured.

In another advantageous embodiment of the method according to the present invention, the three-dimensional design of the induction coil is designed in such a way that the current on the face(s) flows perpendicularly to the parallel areas of the induction coil on a top and a bottom side of the component(s). This ensures uniform heating of the entire face to be machined or the faces to be joined together.

In another advantageous embodiment of the method according to the present invention, the inductive heating according to method step c) is an inductive low- or high-frequency pressure welding method for joining metallic components, in particular components of a gas turbine. The frequencies used may be selected from a range between 0.05 and 2.5 MHz. However, it is also possible for the inductive heating according to method step c) to be inductive soldering for joining metallic components or for eliminating inherent stresses of metallic components. The method according to the present invention allows a plurality of different possible applications in the range of inductive heating of metallic components. For example, a first component may be a blade or a component of a blade of a rotor in a gas turbine, and a second component may be a ring or a disk of the rotor or a blade foot situated on the circumference of the ring or the disk. However, the components may also be components of a blade of a rotor in a gas turbine.

A device according to an embodiment of the present invention for inductive heating of metallic components, in particular components of a gas turbine, where the components each have one or more lateral faces surrounding the particular component cross section, has at least one generator and at least one induction coil, the induction coil being designed in a meandering pattern and shaped around the component(s), in such a way that the induction coil extends over at least a partial area of the lateral face(s) of the component(s) to be heated in the area of one or more faces to be heated. In contrast with conventional devices for inductive heating, machining or heating of the components takes place via an induction coil having a meandering pattern and a three-dimensional design. In this way, the current flow may be guided in such a way that it acts over the entire area of the faces to be machined or the joining faces and thus uniform heating of the entire machining face or joining zone is achieved, independently of the cross section of the components. Furthermore, the current flow between two faces to be joined is increased. In addition, the device according to the present invention allows input of heat into faces of varying width; furthermore, the component to be machined may be easily extracted out of the device because the induction coil used usually does not completely surround the component.

In another advantageous embodiment of the device according to the present invention, the three-dimensional design of the induction coil is adapted to the geometry of the component(s). Due to this adaptation, uniform heating of all faces to be machined in the working range of the induction coil is ensured.

In another advantageous embodiment of the device according to the present invention, the three-dimensional design of the induction coil is designed in such a way that the current on the face(s) flows perpendicularly to the areas of the induction coil parallel to one another on a top side and a bottom side of the components. This also ensures uniform heating of the entire face to be machined or the faces to be joined together.

In another advantageous embodiment, the device has at least one cooling device for the induction coil. The cooling device ensures that there is no damage to the induction coil, e.g., due to the temperature input into the induction coil being too high.

In another advantageous embodiment of the device according to the present invention, inductive heating is an inductive low-frequency or high-frequency pressure welding method for joining metallic components, in particular components of a gas turbine. The frequencies used here may be selected from a range between 0.05 and 2.5 MHz. Due to the uniform heat input regardless of the cross section of the components to be joined, the device according to the present invention is suitable in particular for joining appropriate metallic components. Furthermore, the device may have means which allow inductive low- or high-frequency pressure welding to be performed in a vacuum or in a protective gas atmosphere. This contributes toward the quality of the resulting welds.

In other advantageous embodiments of the device according to the present invention, an insulator is situated at least partially between the induction coil and the component(s) in the area of the sections of the components to be heated or to be joined, the insulator having at least one face which faces the component(s) and is made of a material that does not essentially or at all hinder the magnetic interaction between the induction coil and the components to be heated due to its specific properties. Furthermore, the face of the insulator may be designed to be a distance away from the induction coil and/or the component(s). The insulator may be made of glass, for example, in particular refractory quartz glass, a refractory ceramic or a refractory plastic. In the case of the device, the induction coil is advantageously and reliably insulated when metal vapor is formed due to the vaporization of the surfaces of the components to be heated, thus no plasma is formed and no short circuit occurs between the components and the induction coil. Moreover, the device may also keep on operating continuously and without interference as required in automatic mass production of components, for example, even when a metal vapor is formed. Furthermore, according to an embodiment of the present invention, the magnetic interaction between the insulator and the components is not hindered due to a suitable choice of material of the insulator. Due to a possible spacing of the face of the insulator away from the induction coil, this ensures that there are no stresses between the induction coil and the insulator and/or the component and the insulator due to possible temperature-dependent differences in thermal expansion between these elements.

In additional advantageous embodiments of the device according to the present invention, the insulator is designed in the form of layers or films.

In another advantageous embodiment of the device according to the present invention, the geometry of the face of the insulator facing the component(s) is adapted to the geometry of the component(s) to be introduced. This ensures that there will be no hindrance to the insertion of the component into the induction coil.

The component according to the present invention may be, for example, a so-called BLING or BLISK, which is manufactured in particular using an inductive low- or high-frequency pressure welding method.

### BRIEF DESCRIPTION OF THE DRAWINGS

Additional advantages, features and details of the present invention are derived from the following description of an exemplary embodiment as depicted in the drawings.

FIG. 1 shows a schematic diagram of an induction coil according to the related art;

FIG. 2 shows a schematic diagram of the induction coil according to the present invention in an unfolded state;

FIG. 3 shows a schematic diagram of the induction coil according to the present invention according to FIG. 2 in a folded state;

FIGS. 4a and 4b show schematic diagrams of a device according to the present invention for inductive heating of metallic components.

### DETAILED DESCRIPTION

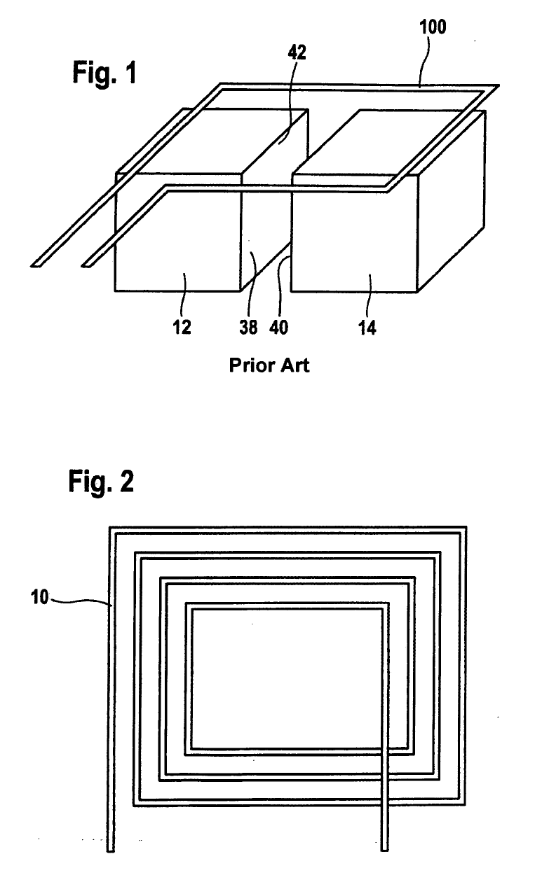

FIG. 1 shows a schematic diagram of an induction coil 100 according to the related art. This shows the flat design of induction coil 100 having two components 12, 14 to which opposing joint faces 38, 40 are to be joined by inductive low- or high-frequency pressure welding. However, due to the flat design of induction coil 100, only a partial area of joining faces 38, 40, namely in particular an edge area 42, which is closest to induction coil 100 is heated. It is apparent that there is no direct heating via induction coil 100 in particular at the center of joining faces 38, 40.

FIG. 2 shows a schematic diagram of an induction coil 10 according to one exemplary embodiment of the present invention. Induction coil 10 is shown in an unfolded state; the meandering design of an induction coil 10 is clearly apparent. Other meandering forms, e.g., having rounded corner areas, are also conceivable. Induction coil 10 is usually made of copper or a copper alloy. Other metals or metal alloys may also be used.

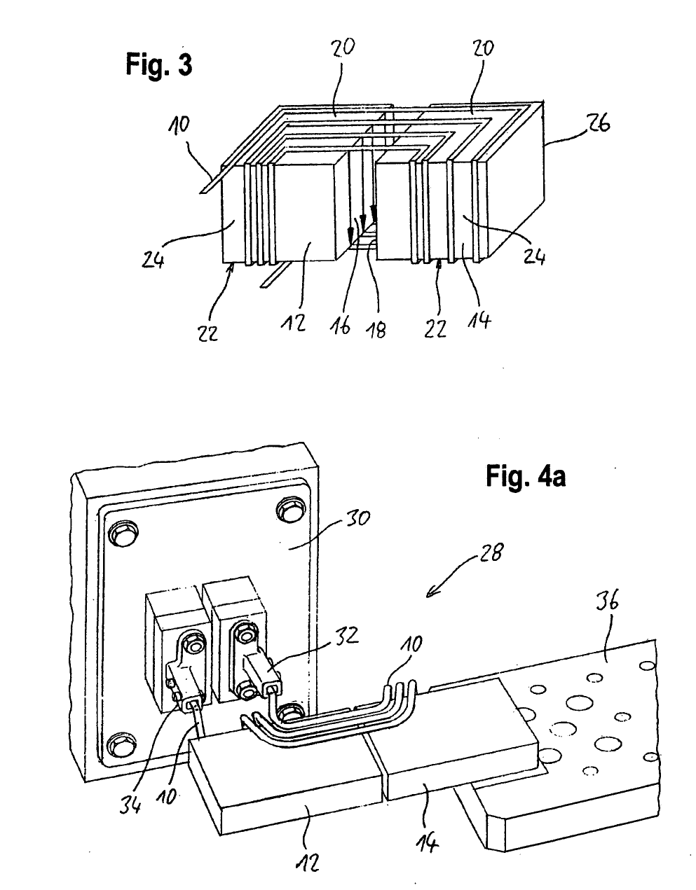

FIG. 3 shows a schematic diagram of induction coil 10 according to FIG. 2 in a folded state. Induction coil 10 may be used in a method for inductive heating of metallic components 12, 14, in particular components of a gas turbine. It is apparent here that components 12, 14 each have a plurality of lateral faces 20, 22, 24, 26 surrounding the particular component cross section, the meandering induction coil being shaped and/or folded around components 12, 14, in such a way that it extends over partial areas of lateral faces 20, 22, 24 of components 12, 14 in the area of joining faces 16, 18 of components 12, 14 to be heated. Furthermore, it is apparent that the three-dimensional design of induction coil 10 has been adapted to the geometry of components 12, 14. Furthermore, due to the design of induction coil 10 shown in the exemplary embodiment, a current is created on joining faces 16, 18 which is perpendicular to the parallel areas of induction coil 10 on top and bottom sides 20, 22 of components 12, 14. The current is represented by black arrows. A uniform current develops, running over the entire area of joining faces 16, 18 and thus permitting uniform heating of joining faces 16, 18 over their entire area.

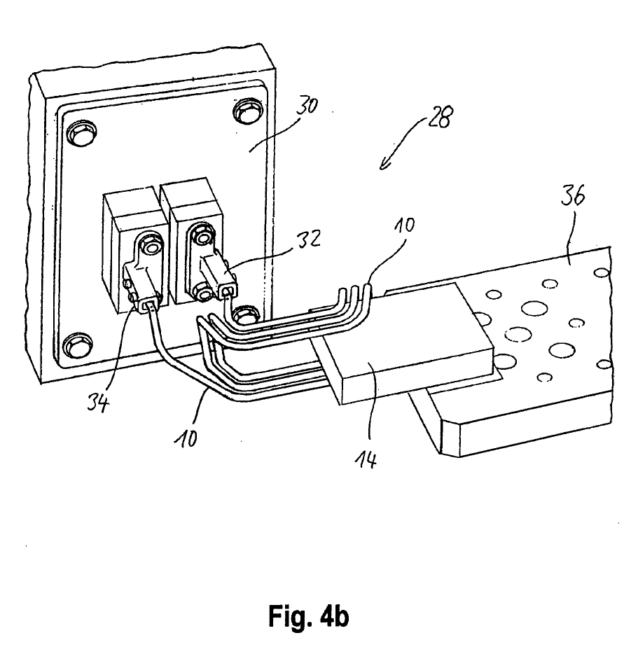

FIGS. 4a and 4b show schematic diagrams of a device 28 for inductive heating of metallic components 12, 14. Device 28 includes a generator 30 and an induction coil 10 in the exemplary embodiment shown here, this induction coil in turn being designed in a meandering pattern and shaped around components 12, 14, in such a way that it extends over a partial area of the lateral faces of components 12, 14 in the area of the faces to be heated or joining faces 16, 18 (see also FIG. 3). It is apparent that the induction coil is connected to generator 30 via two electric terminals 32, 34. A holding and feeding device 36 guides component 14 onto component 12, a corresponding approach being accomplished after sufficient heating of joining faces 16, 18. Inductive heating is accomplished as part of an inductive low- or high-frequency pressure welding method for joining two metallic components 12, 14. The frequencies used in inductive low- or high-frequency pressure welding are selected from a range between 0.05 and 2.5 MHz. FIG. 4b shows device 28 having only one component 14. The meandering three-dimensional design of induction coil 10 is clearly apparent. Induction coil 10 is designed in such a way that component 14 or both components 12, 14 may be readily inserted into induction coil 10. In the case of components 12, 14 having a very large cross section of joining faces 16, 18, a lateral expulsion of material may occur. This may be prevented by the usual measures, e.g., sputter etching. Furthermore, joining faces 16, 18 may be shot-blasted. In addition, overheating of the basic material of components 12, 14 is avoided by a machining allowance in the induction coil area. In the manufacture or repair of blades of a gas turbine, advantageously almost no current flow is detectable in the edge area, so that here again, unwanted influences are avoided.

This exemplary embodiment illustrates that device 28 is suitable for both the manufacture and repair of components and parts of a gas turbine.

What is claimed is:

1. An induction coil for inductive heating of at least one metallic component having at least one lateral face and at least one face to be heated, the induction coil comprising:
a meandering pattern section shaped around the at least one component in such a way that the section extends over at least a partial area of the at least one lateral face of the at least one component to be heated in the area of the at least one face to be heated.

2. The induction coil as recited in claim 1 wherein the at least one induction coil has a three-dimensional design that is adapted to the geometry of the at least one component.

3. The induction coil as recited in claim 1 wherein the at least one lateral face includes a lateral face on a top side of the at least one component and a lateral face on a bottom side of the at least one component, the meandering pattern being arranged in such a way so as to produce a current on the at least one face to be heated, the current flowing perpendicular to areas of the lateral face on the top side and the lateral face on the bottom side that are parallel.

4. The induction coil as recited in claim 1 wherein the at least one component includes a first component and a second component and the at least one face to be heated includes a first joining face of the first component and a second joining face of the second component, the meandering pattern section being shaped around the first and second components such that the meandering pattern section is capable of joining the first joining face and the second joining face.

5. The induction coil as recited in claim 1 further comprising at least one cooling device for cooling the meandering pattern section.

6. The induction coil as recited in claim 1 wherein the at least one component includes a first component and a second component, the meandering pattern section being adapted for an inductive low-frequency or high-frequency pressure welding capable of joining the first component and the second component.

7. The induction coil as recited in claim 6 wherein the meandering pattern section is adapted to join the first component and the second component by inductive low-frequency or high-frequency pressure welding between frequencies of 0.05 and 2.5 MHz.

8. The induction coil as recited in claim 1 wherein the at least one component is at least one component of a gas turbine.

9. A method for inductive heating of at least one metallic component having at least one lateral face and at least one face to be heated, the method comprising:
providing at least one induction coil having a meandering form and operating in working range;
arranging the at least one component and the at least one induction coil so that the least one induction coil is shaped around the at least one component, the at least one induction coil extending over at least a partial area of the at least one lateral face of the at least one component in an area of the at least one face to be heated; and
inductive heating the at least one component in the working range of the at least one induction coil.

10. The method as recited in claim 9 wherein the at least one induction coil has a three-dimensional design that is adapted to the geometry of the at least one component.

11. The method as recited in claim 9 wherein the at least one lateral face includes a lateral face on a top side of the at least one component and a lateral face on a bottom side of the at least one component, the induction coil being arranged in such a way that during the inductive heating step a current is produced on the at least one face to be heated that flows perpendicularly to areas of the lateral face on the top side and the lateral face on the bottom side that are parallel.

12. The method as recited in claim 9 wherein the at least one component includes a first component and a second component, the inductive heating step being an inductive low-frequency or high-frequency pressure welding for joining the first component and the second component.

13. The method as recited in claim 12 wherein the frequencies used in the inductive low-frequency or the high-frequency pressure welding are selected from a range between 0.05 and 2.5 MHz.

14. The method as recited in claim 9 wherein the at least one component includes a first component and a second component, the inductive heating step being inductive soldering for joining the first component and the second component.

15. The method as recited in claim 9 wherein the inductive heating step eliminates inherent stresses in the at least one component.

16. The method as recited in claim 9 wherein the at least one component includes a first component and a second component, the first component being a blade or a component of a blade of a rotor in a gas turbine and the second component being a ring or a disk of the rotor or a blade foot situated on the circumference of the ring or the disk.

17. The method as recited in claim 9 wherein the at least one component is a component of a blade of a rotor in a gas turbine.

18. A device for inductive heating of at least one metallic component having at least one lateral face and at least one face to be heated, the device comprising:
at least one generator; and
at least one induction coil, the at least one induction coil having a meandering pattern and being shaped around the at least one metallic component such that the at least one induction coil extends over at least a partial area of the at least one lateral face of the at least one component in an area of the at least one face to be heated.

19. The device as recited in claim 18 wherein the at least one induction coil has a three-dimensional design that is adapted to the geometry of the at least one component.

20. The device as recited in claim 18 wherein the at least one lateral face includes a lateral face on a top side of the at least one component and a lateral face on a bottom side of the at least one component, the induction coil being arranged in such a way that the induction coil produces a current on the at least one face to be heated, the current flowing perpendicular to areas of the lateral face on the top side and the lateral face on the bottom side that are parallel.

21. The device as recited in claim 18 wherein the at least one component includes a first component and a second component and the at least one face to be heated includes a first joining face of the first component and a second joining face of the second component, the at least one induction coil being shaped around the first and second components such that the at least one induction coil is capable of joining the first joining face and the second joining face.

22. The device as recited in claim 18 further comprising at least one cooling device for cooling the induction coil.

23. The device as recited in claim 18 wherein the at least one component includes a first component and a second component, the at least one induction coil being adapted to join the first component and the second component by inductive low-frequency or high-frequency pressure welding.

24. The device as recited in claim 23 wherein the at least one induction coil is adapted to join the first component and the second component by inductive low-frequency or high-frequency pressure welding between frequencies of 0.05 and 2.5 MHz.

25. The device as recited in claim 24 further comprising a mechanism allowing the inductive low-frequency or high-frequency pressure welding to be performed in a vacuum or in a protective gas atmosphere.

26. The device as recited in claim 18 further comprising an insulator situated at least in areas between the at least one induction coil and the at least one component in the area of the at least one face to be heated, the insulator having at least one face which faces the at least one component that is made of a material that does not significantly or at all hinder the magnetic interaction between the at least one induction coil and the at least one component.

27. The device as recited in claim 26 wherein the at least one face of the insulator is a distance away from the induction coil or the components.

28. The device as recited in claim 26 wherein the insulator is designed in the form of layers or films.

29. The device as recited in claim 26 wherein the geometry of the face of the insulator facing the at least one component is adapted to the geometry of the at least one component.

30. The device as recited in claim 26 wherein the insulator is made of glass, in particular refractory quartz glass, a refractory ceramic or a refractory plastic.

31. The device as recited in claim 18 wherein the at least one component is a BLING or BLISK.

32. The device as recited in claim 18 wherein the at least one component is at least one component of a gas turbine.
